(19) United States
(12) Patent Application Publication
(10) Pub. No.: US 2002/0039260 A1
(43) Pub. Date: Apr. 4, 2002

(54) Twin coil positioner

(76) Inventor: Dan L. Kilmer, Chatsworth, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/870,066

(22) Filed: May 29, 2001

Related U.S. Application Data
(63) Continuation of application No. 08/563,679, filed on Nov. 28, 1995, now abandoned.

(51) Int. Cl. G11B 5/55

(52) U.S. Cl. 360/264.7

(57) ABSTRACT

A family of hard disk drive digital storage systems of different height using common components is provided herein. The family of drives uses similar parts in order to provide economies of scale and overlap of tooling necessary to manufacture the disk drives. The family of drives includes a full height -drive having multiple rotatable disks and a head positioner arrangement for moving data heads relative to the disks. The head positioner arrangement includes an integrally formed head positioner having two coils and a permanent magnet structure having two pairs of fixed substantially flat spaced permanent magnets, and each coil extends through one pair of magnets. This design significantly improves the electrical time constant over previous positioner motor designs. The full-height drive also includes several flux plates and support elements, several of which are manufactured to the same dimensions. The half-height drive includes fewer rotatable disks than the full-height drive, and also includes a head positioner arrangement for mounting the heads relative to the disks. The head positioner arrangement includes a pair of fixed substantially flat spaced permanent magnets manufactured to the dimensions of the magnets used in the full-height drive. The half-height head positioner arrangement has a coil extending between the magnets for controlling head movement.

### FIELD OF THE INVENTION

This invention relates to hard disk digital storage systems, or more particularly, hard disk drive precision head positioning assemblies.

### BACKGROUND OF THE INVENTION

Modern computer systems utilize hard disk digital data storage systems to store program application and related data. Modern disk drive systems typically employ multiple 3.25 inch disks, each disk capable of storing over one gigabyte of data.

Digital disk drive systems record information on circular disks, each disk having a multiplicity of tracks concentrically located thereon. Each disk drive typically contains a plurality of disks, each disk recording surface having one or more magnetic heads which transfer information to or from an external system. Each magnetic head is located on an arm, and all arms are aligned vertically and attached to a common head positioner. The head positioner is driven by a motor so that the arms and magnetic heads move uniformly across the surfaces of the vertically aligned disks. Head positioners are usually mounted to rotate the arms and magnetic heads along an arcuate path over the disks, and head positioning is critical for accurate data transfer and retrieval.

The magnetic data heads are shifted from track to track by energizing a magnetic coil assembly. Alignment of the magnetic coil assembly and head positioner mounting surfaces is critical, as any degree of positional shifting of the data heads may cause read or write errors.

Magnetic head positioners typically comprise a central rotating positioner body having a plurality of rigid positioner arms with magnetic read/write heads mounted resiliently or rigidly at the ends of the positioning arms. The positioning arms are interleaved into and out of the stack of rotating magnetic disks by means of a coil assembly mounted to the head positioner body. The coil typically interacts with a permanent magnet structure, and application of current to the coil in one polarity causes the head positioner and data heads to shift in one direction, while current of the opposite polarity shifts the aforementioned elements in the opposite direction.

The head positioner has associated therewith a voice coil motor, or VCM, which drives the head positioner. The voice coil motor torque constant, Kt, is optimized based on overall system requirements. Since most small disk drives operate from input voltages of 12 and 5 volts, the combinations of DC coil resistance, angular acceleration and maximum peak angular velocity of the positioner constrain the range of torque constants. Most 3½ inch disk drives have torque constants in the range of approximately 18 ounce-inches per ampere.

Since disk drive outline sizes are fixed by environment and convention, and permanent magnet energy products are limited to values in the range of about 40 MGOe (Mega-Gauss-Oersted), most disk drive designs tend to fall into narrow parametric design bands. Once the designer establishes drive size, system capacity, and system performance requirements, the range of design alternatives for the head positioner and associated VCM are relatively constrained. System design establishes a target Kt, and the limited physical space for the VCM mandates a narrow range of possible magnet assembly configurations. These constraints allow a range of possible coil designs, wherein coil design is based on wire size and DC resistance. The desired Kt depends on the number of wire turns, and fixing the coil geometric parameters limits the range of inductance (L) and DC resistance (R).

One important parameter of the VCM is the electrical time constant, which is defined as the time required for the coil current to rise to 63% of its final steady state value when a constant voltage is applied to a stationary coil. The electrical time constant in a single coil is given by L/R. For hard disk drives, inductance L and resistance R fall into narrow ranges, so few options are available for altering the electrical time constant. The electrical time constant must, however, occasionally be shortened to improve seek performance for short seeks. Single track seek times less than one millisecond are not uncommon, and such short seeks can generally be improved if shorter time constants are attainable, since motor torque is directly proportional to coil current. Hence, if coil current can be increased at faster rates, motor torque can be developed faster thereby resulting in faster seek performance.

Conventional modern disk drive assemblies comprise different disk configurations and different sized components depending on space requirements, and hard drive configurations currently include full-height and half-height units. Half-height units are designed to fit into spaces formerly occupied by floppy drive units, and use approximately half the disks of a full-height unit. Full-height units are approximately 1.625 inches high, while half-height units are approximately one inch high. While many of the parts in full-height and half-height units are identical, such as disks, magnetic heads, etc., other parts differ in overall dimensions, such as the head positioner and permanent magnet structure.

A common scheme for providing a permanent magnet assembly for full-height and half-height drives is to provide an upper magnet and a lower magnet having a coil disposed within the gap between the magnets, said coil moving freely between the magnets and attached to the positioner assembly. Such an array applies to full-height drives and half-height drives, with half-height drives having shorter head positioner assemblies and smaller coils disposed between smaller magnets. Hence, while performing the same general tasks, full-height and half-height hardware is currently specially manufactured depending on the drive size. Such special manufacturing requires specific tooling, cutting, and assembly procedures, all of which slow down production of the disk drives and may require multiple assembly lines at all stages of manufacture.

While some disk drives have redundant features, such as multiple means for writing to a single disk or multiple head positioner assemblies for writing to selected groups of disks, these previous solutions require redundant electronics executing different commands at the same time. Additional programming and/or electronics requirements are inherently more complicated and expensive, and thus redundancy of parts adds to, rather than decreases, overall cost.

Accordingly, a principal object of the present invention is to provide an improved magnetic head positioner with high precision head positioning mounting surfaces providing high accuracy and consistency in the positioning of the magnetic heads and superior electrical time constant performance while simultaneously providing full-height and half-height drives utilizing similar parts, tooling, cutting, and other manufacturing steps wherever possible.

It is a further object of the current invention to provide a disk drive unit utilizing similar parts wherein the performance of the system maintains high accuracy and excellent overall system performance.

It is yet another object of the current invention to provide hard disk drives utilizing similar parts wherein the use of similar parts does not add to the complexity and/or overall cost of the system.

### SUMMARY OF THE INVENTION

In accordance with one aspect of the present invention, there is provided a family of hard disk drive digital storage systems of different height using common components.

One feature of the invention involves a full-height drive which includes multiple rotatable disks, magnetic heads for exchanging data with the disks, and a head positioner arrangement for moving the heads relative to the disks. The head positioner arrangement includes two pairs of fixed substantially flat spaced permanent magnets and a movable head positioner supporting the heads in proximity to the disks. The head positioner has two coils, with each coil extending between one pair of magnets for controlling the movement of the heads across the disk surfaces. The coils on the head positioner assembly are fixed thereon and move together, and the coils are electrically coupled.

In accordance with another aspect of the current invention, there is a half-height drive including rotatable disks, magnetic heads for exchanging data with the disks, and a head positioner arrangement for mounting the heads relative to the disks. The head positioner arrangement includes a pair of fixed substantially flat spaced permanent magnets. The half-height head positioner arrangement also supports the heads in proximity to the disks, and the arrangement has a coil extending between the magnets for controlling head movement.

In accordance with another aspect of the current invention, the magnets for the full height drive are identical with the magnets for the half-height drive. Further, several flux plates used in both the full-height and half-height drives have substantially similar dimensions, as well as several end spacers, crash stop members, and spacing members. This use of similar parts provides economies of scale and overlap of tooling necessary to manufacture the disk drives.

In accordance with another feature of the invention, the coils of the full-height drive has the same geometric outline as the coil in the half-height drive, therefore providing, in conjunction with the respective permanent magnet structures, better linearity at the stroke ends as compared to previous single coil full-height VCM designs. This linearity improvement minimizes the magnet overlap at stroke ends due to use of thinner magnets in the twin coil design, thereby saving space and reducing magnet cost. Wiring requirements necessary to provide coils having similar dimensions and equivalent resistances and linear performance requires the coils of the full-height drive to be approximately three wire sizes larger than the wiring used in the half-height drive. For the dual coil full-height design, the VCM electrical time constant is lower for the twin coil design compared to an equivalent torque constant and resistance for a single coil since the separation of turns results in lower inductance for essentially the same motor torque constant and DC resistance.

Other objects, features, and advantages of the present invention will become more apparent from a consideration of the following detailed description and from the accompanying drawings.

### DESCRIPTION OF THE DRAWINGS

FIG. 1 is a side view of a full-height hard disk drive system in accordance with the present invention.

FIG. 2 is a side view of a half-height hard disk drive system in accordance with the present invention.

FIG. 3 is an exploded view of the permanent magnet arrangement for a full-height drive in accordance with the present invention.

FIG. 4 is a head positioner assembly for use in a full-height disk drive system in accordance with the present invention wherein two coils are located thereon.

FIG. 5 is a drawing of a coil for use in both the half-height and full-height systems.

FIG. 6 is an exploded view of the permanent magnet arrangement for a half-height drive in accordance with the present invention.

FIG. 7 is a head positioner assembly for use in a half-height disk drive system in accordance with the present invention.

FIG. 8 is a schematic drawing of the twin-coil arrangement of the present invention.

FIG. 9a is a top view of an upper flux plate and middle flux plate of the full-height drive of the current invention, and the top flux plate of the half-height drive of the current invention.

FIG. 9b is a top view of a lower flux plate of the full-height drive of the current invention, and the bottom flux plate of the half-height drive of the current invention.

FIGS. 10a and 10b are plots of VCM coil current versus time for a twin coil full-height motor design in accordance with the present invention.

FIGS. 11a and 11b are plots of VCM coil current versus time for a prior art single coil full-height motor design.

FIGS. 12a and 12b are plots of VCM coil current versus time for a single coil half-height motor design in accordance with the design illustrated in FIGS. 5-7, using parts common to the twin coil full-height drive.

FIGS. 13a and 13b are plots of VCM coil current versus time for a prior art single coil half-height motor design of an older product.

FIG. 14 shows the preferred magnetic flux arrangement for the full-height twin coil magnet structure shown in FIG. 3.

### DESCRIPTION OF THE PREFERRED EMBODIMENT

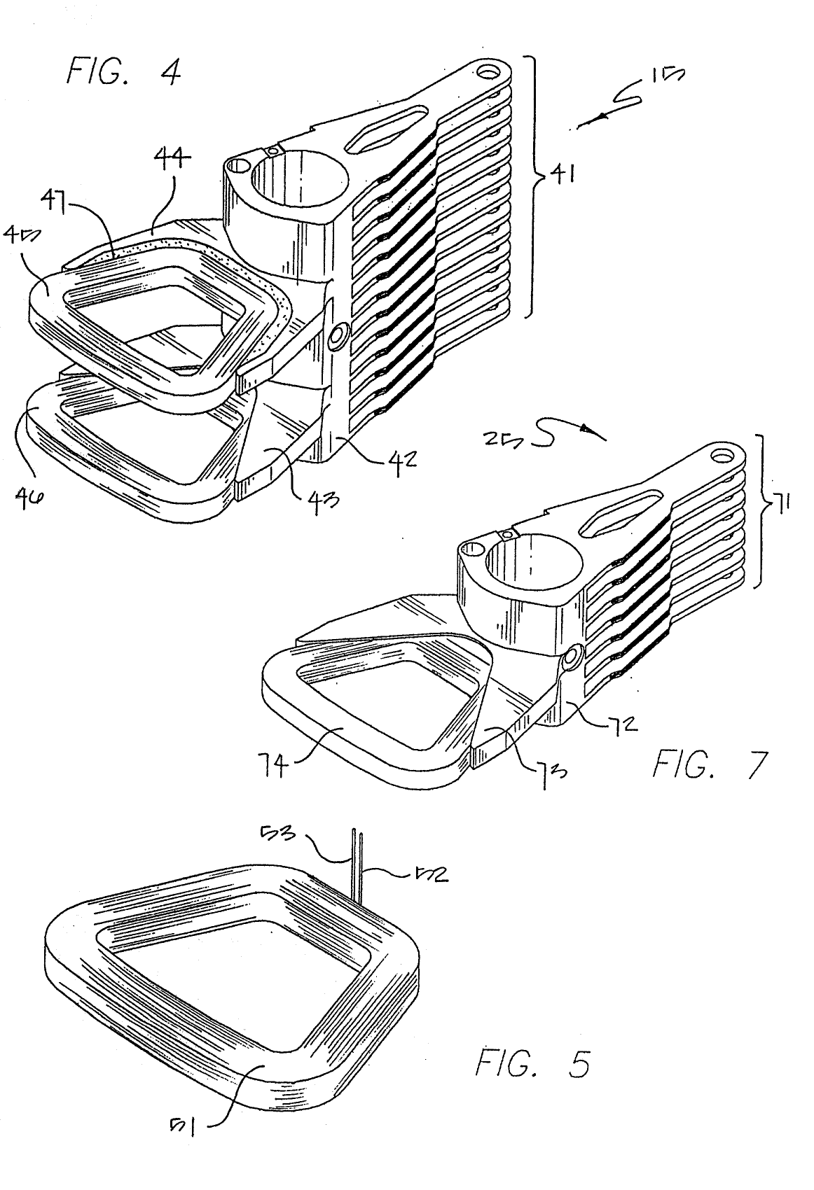

Referring more particularly to the drawings, FIG. 1 illustrates a side view of a full-height hard disk drive 10 with its upper housing cut away in accordance with the current invention. Full-height hard disk drive 10 includes a plurality of rigid magnetic storage disks 11 which are coaxially stacked in an equally spaced tandem relationship on full-height spindle 13. The plurality of magnetic storage disks 11 rotate about full-height spindle 13 at a relatively high rate of rotation. Full-height head positioner unit 15 (shown in more detail in FIG. 4) includes a plurality of interleaved head positioner arms 41, each having one or more magnetic heads mounted thereon for reading and writing information magnetically to rigid magnetic storage disks 11. Full-height head positioner unit 15 rotates about a stationary axis, causing positioner arms 41 to pass into and out of magnetic storage disks 11. The full-height drive 10 includes full-height permanent magnet structure 12, shown in more detail in FIG. 3, which comprises four magnets which interact with two magnetic coils located on full-height head positioner unit 15. The interaction between the four magnets in full-height permanent magnet structure 12 and the two magnetic coils on full-height head positioner unit 15 causes rotation of full-height head positioner unit 15 and a sweeping of full-height head positioner arms 41 across the surface of full-height magnetic storage disks 11. Full-height permanent magnet structure 12 and full-height spindle 13 are fixedly and rotatably mounted, respectively, to full-height base 14 which houses the drive electronics.

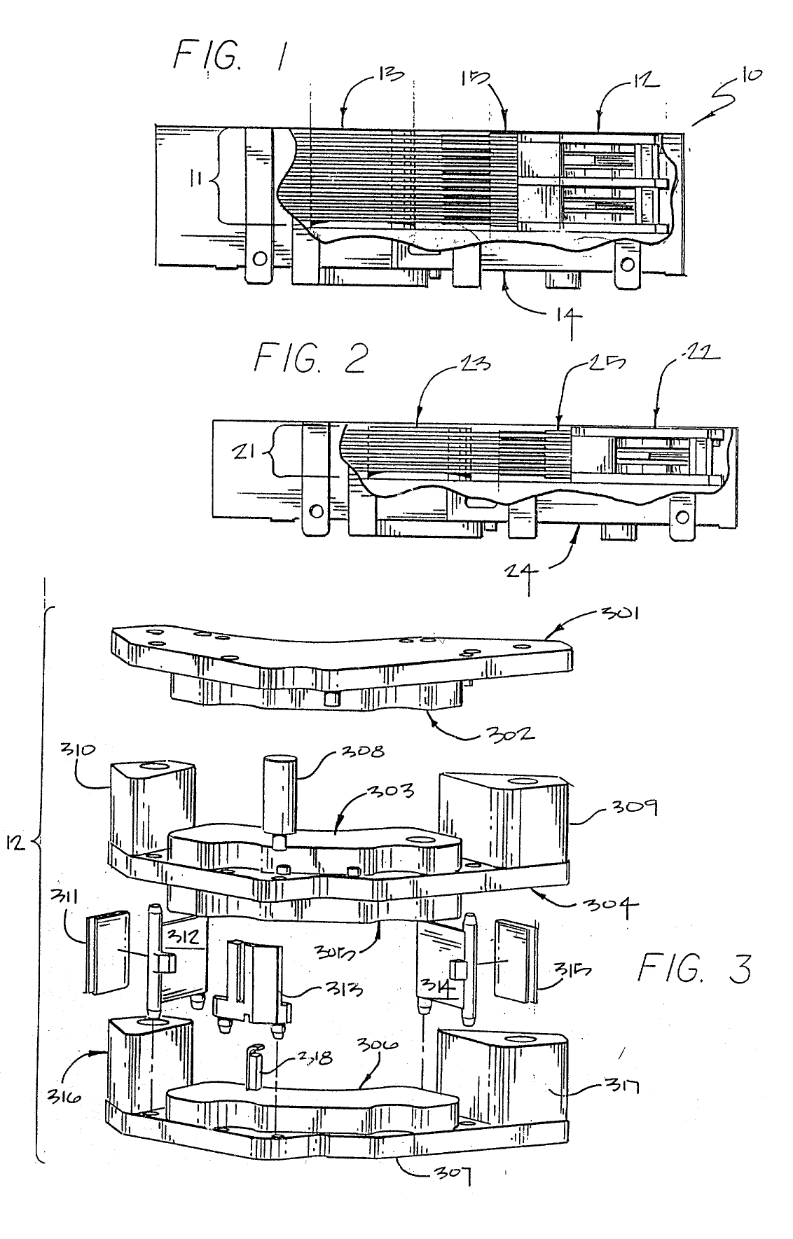

FIG. 2 shows the half-height drive configuration of the current invention. Again, half-height hard disk drive unit 20 includes a plurality of magnetic storage disks 21 stacked and mounted on half-height spindle 23. As the name implies, half-height drive 20 is approximately half the height of full-height drive 10. While the dimensions of the drives are not specifically limited to those illustrated, the drive heights currently contemplated for the devices shown are 1.625 inches for the full-height drive 10 and 1.00 inches for the half-height drive 20. Approximately half as many disks are used in the half-height drive as in the full-height drive. Again, simply for the purpose of illustration and not as a limitation, the full-height drive 10 uses 12 disks while the half-height drive 20 uses 6 disks.

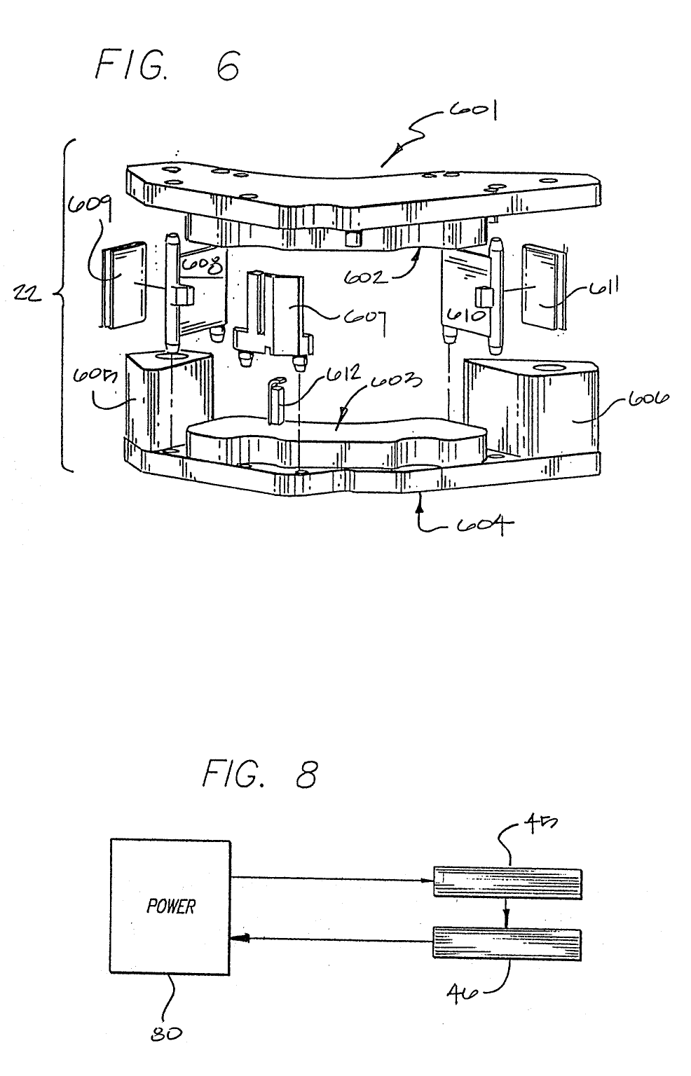

Half-height drive 20 also comprises a half-height head positioner unit 25 (shown in more detail in FIG. 7) which includes a plurality of interleaved head positioner arms 71, each having magnetic heads mounted thereon. Half-height head positioner unit 25 rotates about an axis, causing positioner arms 71 to pass into and out of magnetic storage disks 21. The half-height drive 20 further includes half-height permanent magnet structure 22, shown in more detail in FIG. 6, which comprises two magnets which interact with a magnetic coil located on half-height head positioner unit 25. As with full-height drive 10, the interaction between the two magnets in full-height permanent magnet structure 22 and the magnetic coil on half-height head positioner unit 25 causes rotation of half-height head positioner unit 25 and a sweeping of half-height head positioner arms 71 across the surface of half-height magnetic storage disks 21. Half-height permanent magnet structure 22 and half-height spindle 23 are fixedly and rotatably mounted, respectively, to full-height base 24 which houses the drive electronics.

As can be appreciated by the drives in FIG. 1 and in FIG. 2, as well as the comparison between the exploded views of the permanent magnet structures in FIG. 3 and FIG. 6, many of the parts in each drive may be used in the other drive. FIG. 3 illustrates an exploded view of the full-height permanent magnet structure 12. Upper flux plate 301 is attached to upper top magnet 302 and upper end spacers 309 and 310. The magnets shown in FIG. 3 and FIG. 6 are constructed of any high energy magnetic product, but the preferred material for the application is a nickel-plated neodymium iron boron. Although not specifically limited in dimension, the magnets shown in FIG. 3 and FIG. 6 are approximately 0.12 inches in thickness, providing relatively constant linear response for the system.

All flux plates and end spacers in the full-height and half-height permanent magnet structures 12 and 22 are constructed of a low carbon steel, or magnetic steel, and are nickel-plated to prevent corrosion. Other types of low-carbon steel or other metallic metals may be used to construct the aforementioned parts. Spacing member 308 maintains the separation between upper flux plate 301 and middle flux plate 304, and is constructed of plastic. Middle flux plate 304 is attached to lower top magnet 303 on its upper side and upper bottom magnet 305 is attached to the bottom of middle flux plate 304. Attachment of all magnets in FIG. 3 to all flux plates in FIG. 3 may be by any means generally available to fasten two pieces of metal together which does not impede the magnetic strength of the magnets, including but not limited to welding or metal-to-metal adhesion, such as an anaerobic or other adhesives used to join metal parts. Upper end spacers 309 and 310 are also joined to the upper and middle flux plates 301 and 304 by welding or adhesive, and include holes for mounting the full-height permanent magnet structure 12 to the full-height base 14.

The lower portion of full-height permanent magnet structure 12 includes lower flux plate 307, lower end spacers 316 and 317, and lower bottom magnet 306. The structure also includes two-prong latch housing 313 disposed between the middle flux plate 304 and lower flux plate 307. The full-height permanent magnet structure 12 also comprises crash-stop protection, including left crash stop member 312 and right crash stop member 314, both constructed of a molded high-strength plastic material. The left and right crash stop members 312 and 314 are braced by left spring 311 and right spring 315, respectively, and are constructed of any stiff material having spring-like qualities, with the preferred material being a heat-treated beryllium copper. A latch magnet assembly 318 is mounted to the bottom lower magnet 306. As shown in FIG. 3, various holes are located within the top flux plate 301, middle flux plate 304, and bottom flux plate 307, all of which are useful for tooling purposes.

The full-height head positioner assembly 15 is shown in FIG. 4. The full-height head positioner assembly 15 includes head positioner body 42 and a plurality of head positioner arms 41. The head positioner assembly 15 may be manufactured for use with a different number of disks depending on the disk drive requirements, but as shown in FIG. 4, and not by way of limitation, a full-height drive may accommodate twelve disks using thirteen head positioner arms 41. Two coils, upper coil 45 and lower coil 46, are integrally formed to full-height head positioner assembly 15 at head positioner body 42. The coils are mounted to head positioner body 42 using integrally-formed upper attachment member 44 and integrally-formed lower member 43. The coils are bonded to the integrally-formed members by a UV curable adhesive 47 which has an acrylic base. Any means for joining these elements together, including but not limited to epoxies or other adhesives may be used. As shown in the schematic diagram of FIG. 8, the upper coil 45 and lower coil 46 are joined in series and connected to power source 80.

The coils 45 and 46 are electrically connected in series rather than in parallel so that the same amount of current flows through each coil under all extremes of conditions. The flux path of the magnetic circuit is also in series so that all four magnets have the same magnetic polarity. The preferred magnetic flux path for the full-height permanent magnet structure 12 shown in FIG. 3 is presented in FIG. 14. As shown therein, flux travels from south to north poles via flux paths 1401-1408. This arrangement provides for strong and weak magnets to average out, making the flux in the two working air gaps nearly independent of minor variations in magnet strength. Therefore, there are almost no output torque differences between upper and lower coils.

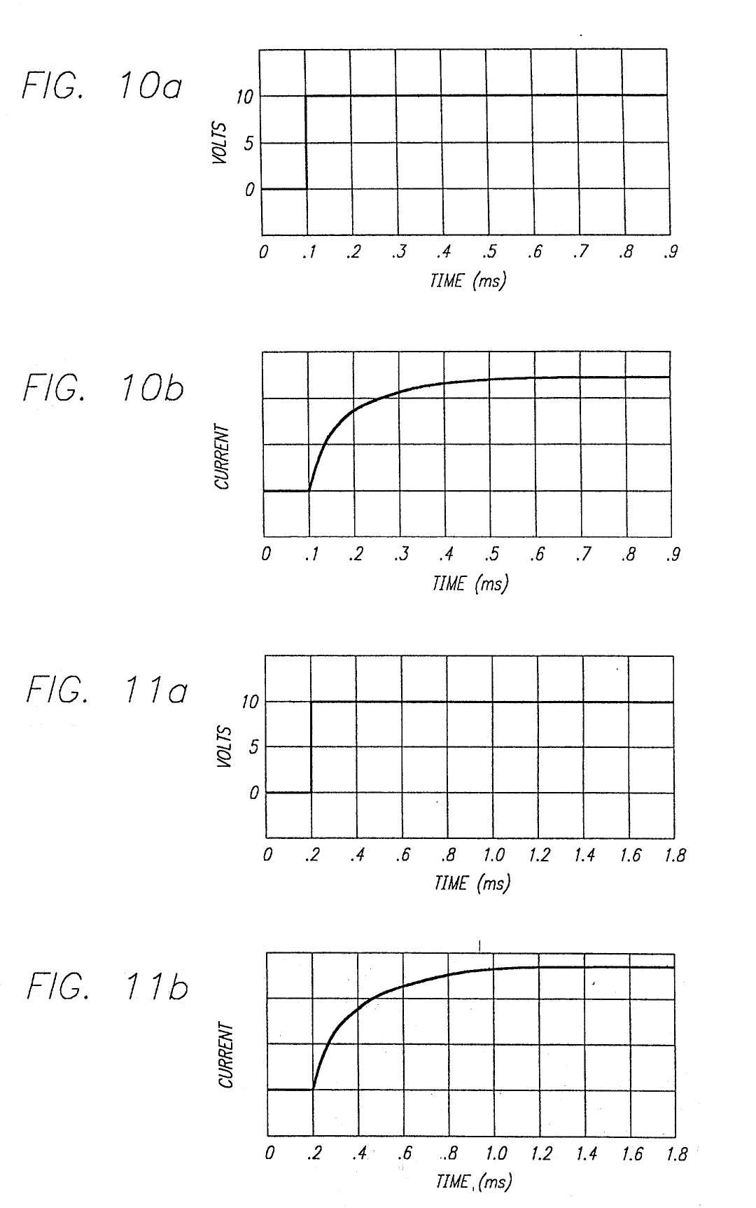

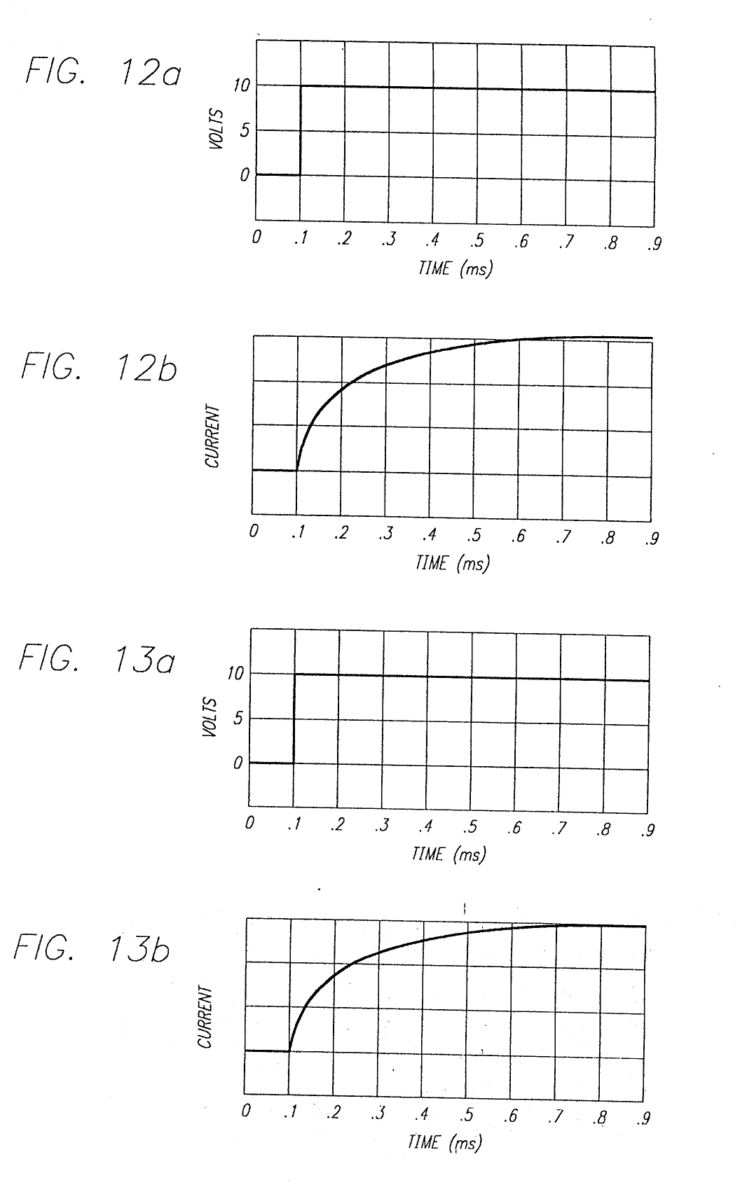

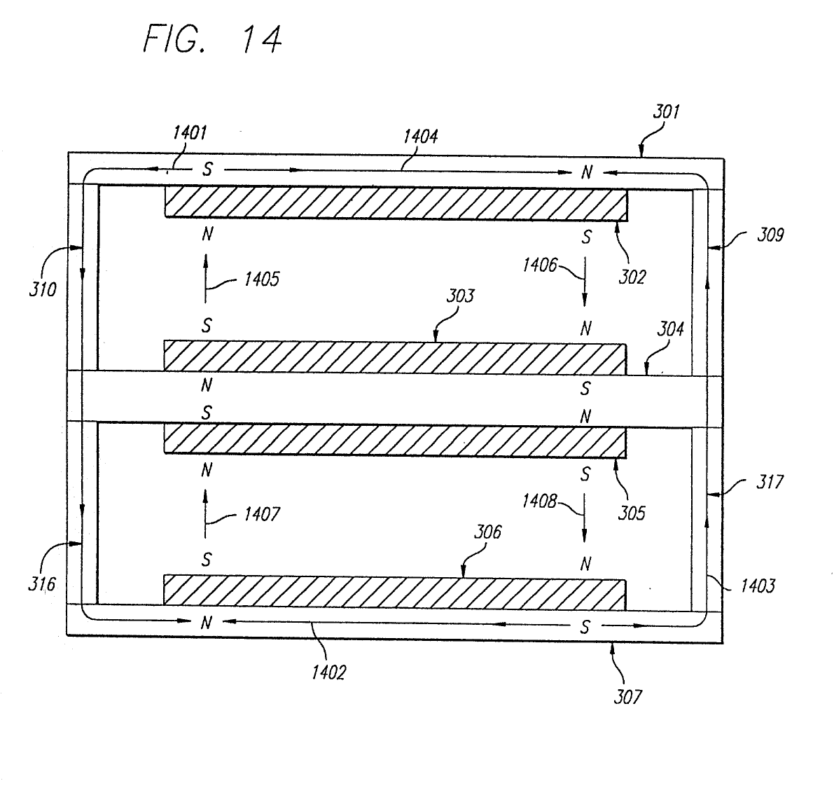

Prior systems typically utilized thicker magnets and a single coil in full-height drives. The advantages of the twin coil design are that the thinner magnets 302, 303, 305, and 306 provide better torque constant linearity due to lower leakage. The twin coil design provides better linearity at the stroke ends so that the overall efficiency deficit is relatively low. Further, the VCM electrical time constant is lower for the twin coil design compared to an equivalent torque constant and resistance single coil since the physical separation of turns results in lower inductance for essentially the same DC resistance. The system performance and associated time constant for the twin coil design is illustrated in FIGS. 10 and 11. FIG. 10 is a plot of VCM coil current for a twin coil full-height motor design wherein the measured electrical time constant is 115 microseconds. FIG. 11 is a plot of VCM coil current versus time for a single coil full-height motor design of an older product, where the measured electrical time constant is 225 microseconds. It is important to note that the time scale in FIGS. 11a and 11b are twice that of the time scales of FIG. 10.

Depending on overall height and performance requirements, the same end plates and spacers can be utilized. For example, middle flux plate 304 and bottom flux plate 307 have similar dimensions, as do upper end spacer 310 and lower end spacer 316. Upper end spacer 309 is the same size as lower end spacer 317, and all magnets 302, 303, 305, and 306 are of the same dimension. As a result, tooling costs may be minimized as use of redundant parts provides economies of scale for mass production of the drives.

Additionally, distribution of torque at two points closer to the full high positioner bearings may improve dynamic resonance performance over a single (flat) coil placed at the center of the positioner housing. Mechanical response (bode) data has demonstrated good results with no discernible performance problems traceable to twin coil design. Deliberate unbalance of torque distribution between upper and lower coils of up to twenty percent unbalance also demonstrates minimal adverse dynamic response variation.

For a limited volume of space, a twin coil VCM design exhibits better torque constant linearity. Torque constant linearity improves because the magnet and coil thicknesses are roughly half that of an equivalent single coil design designed to fit in the same volume of space. This improvement is due to lower leakage flux and better flux distribution within the working air gap from thinner magnets and coils. Further, this twin coil design improves heat dissipation due to dual coil face surface area and a shorter path from the interior of each coil to the coil surface.

The full-height split design shown in FIG. 4 improves the VCM electrical time constant over the time constants of prior art single coil full-height designs. By splitting the coils into two coils of N/2 turns in lieu of a single coil of N turns, the electrical time constant is reduced by about a factor of two, assuming that inductive coupling between the two separate coils is negligible. The single coil design has N turns, an inductance of L₁, which is proportional to N², a DC resistance of R, and an electrical time constant of L₁/R, which is proportional to N²/R. A series connected twin coil VCM design having coils effectively one half an equivalent single coil VCM design, a torque constant essentially equal to the single coil design, and negligible mutual inductive coupling between coils yields a design having N/2+N/2=N total turns, an inductance of L₂+L₂, which is proportional to N²/4+N²/4=N²/2, a DC resistance of R/2+R/2=R, and an electrical time constant of (L₂+L₂)/(R/2+R/2)=N²/(2R).

From the single coil and twin coil designs of a full-height drive outlined above, the electrical time constant of a twin coil VCM should be about half that of a single coil design of equal Kt and overall motor size, neglecting second order effects. As shown in FIGS. 10 and 11, such a reduction in time constant results from using the proposed design. Note that in order to prevent current unbalance between coils and the resultant torque unbalance, the twin coil design must be electrically connected in series.

FIG. 5 illustrates the design of a single coil. As may be appreciated from FIG. 4 and FIG. 7, the coil for the full-height design is geometrically identical to the half-height design. However, in order to achieve similar torque constants (Kt), full-height coils 45 and 46 and half-height coil 74 must have a different number of turns. The two full-height coils 45 and 46 combined have approximately the same number of turns as the half-height coil 74, which requires approximately three wire-size differences, where the full-high coils have the larger diameter wire. Power is supplied to the coils by wire leads 52 and 53, where the twin coils are electrically connected in series so that current flows in each coil.

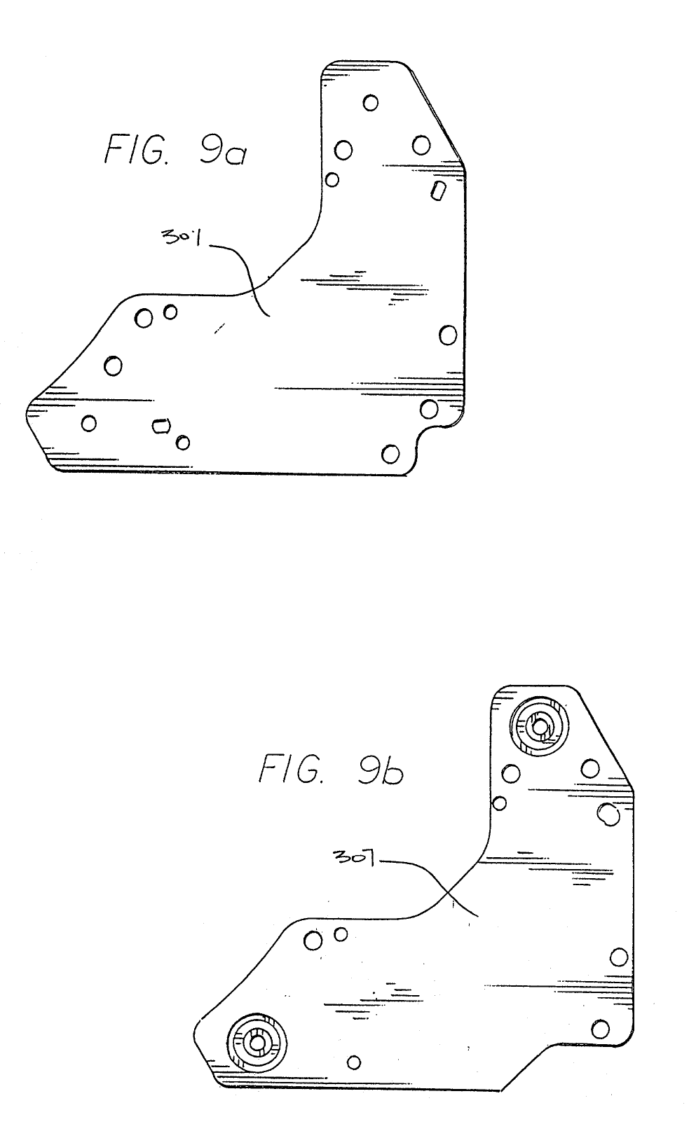

FIG. 6 illustrates the half-height magnet design of the current invention. Upper flux plate 601 is attached to upper magnet 602 and end spacers 605 and 606. Latch housing 607 maintains the separation between upper flux plate 601 and lower flux plate 604, and is constructed of plastic. Lower magnet 603 is attached to the bottom of lower flux plate 604. Attachment of both magnets in FIG. 6 to both flux plates in FIG. 6 may be by any means generally available to fasten two pieces of metal together which does not impede the magnetic strength of the magnets, including but not limited to welding or metal-to-metal adhesion. The preferred means of joining the members is an anaerobic or other adhesive used to join metal parts. End spacers 605 and 606 are also joined to the upper and lower flux plates 601 and 604 by welding or adhesive, and include holes for mounting the half-height permanent magnet structure 22 to the half-height base 24. Half-height permanent magnet structure 22 also comprises crash-stop protection identical to that of full-height permanent magnet structure 22, including left crash-stop member 608 and right crash-stop member 610, both constructed of a high-strength plastic material. Left and right crash-stop members 608 and 610 are braced by left spring 609 and right spring 611, respectively, and are constructed of any stiff material having spring-like qualities in a tight environment, with the preferred material being beryllium copper. A latch magnet assembly 612 is mounted to the bottom lower magnet 603. Various holes are located within the top flux plate 601 and bottom flux plate 604, all of which are useful for tooling purposes.

Whereas most parts from previous full-height and half-height drives were individually fabricated and required special tooling, several parts from the full-height drive 10 may be utilized in half-height drive 20. Middle flux plate 304, lower flux plate 307, and lower flux plate 604 all have substantially similar dimensions, as shown in FIG. 9a. Upper flux plate 301 and top flux plate 601 also have equivalent dimensions, as shown in FIG. 9b. Upper end spacer 309 and lower end spacer 317 are fabricated to the same specifications as end spacer 606, and upper end spacer 310, lower end spacer 316, and end spacer 605 have the same overall dimensions. The crash stop members 312, 314, 608, and 610 are interchangeable, as are springs 311, 315, 609, and 611. The springs 311, 315, 609, and 611 may have slightly different preload and spring rate between half-high and full-high designs. Further, all magnets 302, 303, 305, 307, 602, and 603 as well as latch housings 313 and 607 are fashioned in the same manner and may be used in either the half-height or full-height drives. Although various dimensions may be utilized in the proposed implementation, when fully assembled, the permanent magnet structure 12 of the full-height drive of the illustrated implementation is in the order of 1.25 inches high, while the half-height drive permanent magnet structure 22 of the illustrated implementation is in the order of .7 inches.

From FIG. 7, the half-height head positioner assembly 25 includes half-height positioner body 72 and a plurality of positioner arms 71. Again, while FIG. 7 illustrates a half-height head positioner assembly 25 having seven positioner arms for use with six disks, a half-height positioner may be manufactured for use with a different number of disks depending on the disk drive requirements. Integrally-formed member 73 holds coil 74.

While the invention has been described in connection with specific embodiments thereof, it will be understood that the invention is capable of further modifications. For example, some magnetic circuit designs reduce or eliminate the need for magnetic material side spacers by increasing the thickness of the plates supported by the side spacers. It is to be understood that the foregoing detailed description and the accompanying drawings relate to one illustrative implementation of the present invention. The invention is not limited by this one implementation. This application is intended to cover any variations, uses or adaptations of the invention following, in general, the principles of the invention, and including such departures from the present disclosure as come within known and customary practice within the art to which the invention pertains.

What is claimed is:

1. A family of hard disk drive digital storage systems of different height using common components comprising:
a half-height drive including a plurality of rotatable disks, magnetic heads for exchanging data with said disks, a head positioner arrangement for mounting said heads with respect to said disks, said head positioner arrangement including a permanent magnet structure having a pair of fixed substantially flat spaced permanent magnets and a plurality of flux plates and end spacers; and a movable head positioner supporting heads in proximity to said disks, said movable head positioner having a coil extending between said magnets for controlling the movement of said heads; and
a full-height drive including rotatable disks, magnetic heads for exchanging data with said disks, a head positioner arrangement for moving said heads with respect to said disks, said head positioner arrangement including a permanent magnet structure having a plurality of flux plates and end spacers and at least two pair of fixed substantially flat spaced permanent magnets, and a movable head positioner supporting said heads in proximity to said disks, said movable head positioner having two coils with each coil extending between one of said pairs of magnets for controlling the movement of said heads;
said coils being mounted on said head positioner to move together, and said coils being electrically coupled; and
said pairs of magnets for said full-height drive being identical with said pair of magnets for said half-height drive, and each of said plurality of flux plates and end spacers for said full-height drive being substantially identical with flux plates and end spacers of said half-height drive.

2. The family of hard disk drive digital storage systems of claim 1, wherein said plurality of flux plates in said full-height drive include a first pair of flux plates having substantially identical dimensions and a lower flux plate, and said plurality of flux plates in said half-height drive includes a top flux plate having substantially identical dimensions to said first pair of flux plates and a bottom flux plate having substantially identical dimensions to said lower flux plate.

3. The family of hard disk drive digital storage systems of claim 2, wherein said coils of the full-height drive are interposed between said pairs of magnets in the full-height permanent magnet structure.

4. The family of hard disk drive digital storage systems of claim 1, wherein said two coils in said full-height drive are coupled in series.

5. The family of hard disk drive digital storage systems of claim 4, wherein said two coils in said full-height drive comprise approximately the same number of total windings as the coil in the half-height disk drive.

6. The family of hard disk drive digital storage systems of claim 1, wherein all magnets in said full-height drive and said half-height drive have substantially identical dimensions.

7. The family of hard disk drive digital storage systems of claim 6, wherein all magnets in said full-height drive are coupled in series.

8. The family of hard disk drive digital storage systems of claim 7, wherein all magnets in said half-height drive are coupled in series.

9. The family of hard disk drive digital storage systems of claim 1, wherein said hard disk drive systems have a VCM electrical time constant associated with said full-height drive, saod VCM electrical time constant being lower than an equivalent torque constant and resistance for an equivalent system employing a single coil.

10. A class of hard disk -drive digital storage systems comprising:
a full-height drive, comprising:
a full-height head positioner arrangement, comprising a full-height head positioning member, a plurality of coils affixed to said full-height head positioning member, and a full-height magnet arrangement, wherein said full-height magnet arrangement comprises:
at least two pair of magnets; and
an upper flux plate, a middle flux plate, and a lower flux plate;
wherein said coils are interposed between said pairs of magnets, said pairs of magnets are substantially dimensionally identical, and at least two of said upper flux plate, said middle flux plate, and said lower flux plate are substantially dimensionally identical; and
a half-height drive, comprising:
a half-height head positioner arrangement, comprising a half-height head positioning member, at least one half-height coil affixed to said half-height head positioning member, wherein said half-height coils are substantially dimensionally identical to said full-height coils, and a half-height magnet arrangement comprising at least one pair of magnets and a top flux plate and a bottom flux plate;
wherein said half-height coils are interposed between said pairs of magnets, said pairs of magnets are substantially dimensionally identical, and further wherein at least two of said upper flux plate, said middle flux plate, and said top flux plate are substantially dimensionally identical.

11. The class of hard disk drive digital storage systems of claim 10, wherein said coils of the full-height drive are interposed between said pairs of magnets in the full-height permanent magnet structure.

12. The class of hard disk drive digital storage systems of claim 10, wherein said two coils in said full-height drive are coupled in series.

13. The class of hard disk drive digital storage systems of claim 10, wherein said two coils in said full-height drive comprise approximately the same number of total windings as the coil in the half-height disk drive.

14. The class of hard disk drive digital storage systems of claim 10, wherein all magnets in said full-height drive and said half-height drive have substantially identical dimensions.

15. The class of hard disk drive digital storage systems of claim 10, wherein all magnets in said full-height drive are connected in series.

16. The class of hard disk drive digital storage systems of claim 10, wherein all magnets in said half-height drive are connected in series.

17. The class of hard disk drive digital storage systems of claim 10, wherein said two coils in said full-height drive comprise approximately the same number of total windings as the coil in the half-height disk drive.

18. The class of hard disk drive digital storage systems of claim 10, wherein said hard disk drive systems have a VCM electrical time constant associated with said full-height drive, saod VCM electrical time constant being lower than an equivalent torque constant and resistance for an equivalent system employing a single coil.

19. A permanent magnet structure for use in a hard disk drive, comprising:
a lower flux plate;
a middle flux plate;
an upper flux plate;
an upper pair of magnets, comprising an upper top magnet and a lower top magnet, wherein said upper top magnet is connected to said upper flux plate and said lower top magnet is connected to an upper side of said middle flux plate; and
a lower pair of magnets, comprising an upper bottom magnet and a lower bottom magnet, wherein said upper bottom magnet is connected to a lower side of said middle flux plate, and said lower bottom magnet is connected to said lower flux plate.

20. The permanent magnet structure of claim 19, wherein said top flux plate is substantially dimensionally identical to said middle flux plate.

21. The permanent magnet structure of claim 19, wherein all magnets in said permanent magnet structure are coupled in series.

22. The permanent magnet structure of claim 19, further comprising a plurality of end spacers separating said upper flux plate from said middle flux plate and said middle flux plate from said lower flux plate.

23. The permanent magnet structure of claim 19, wherein all of said magnets are substantially dimensionally similar.

24. The permanent magnet structure of claim 23, wherein all of said magnets are less than approximately .15 inches in thickness.

25. The head positioner permanent magnet structure of claim 17, wherein all magnets in said permanent magnet structure are coupled in series.

26. A hard disk drive storage system comprising:
an integrally formed head positioner having a plurality of arms located thereon;
at least two coils affixed to said head positioner; and
a permanent magnet structure having a plurality of pairs of head positioning magnets;
wherein said coils are interposed between said pairs of head positioning magnets.

27. The hard disk drive storage system of claim 26, wherein said permanent magnet structure further comprises a lower flux plate, a middle flux plate, and an upper flux plate.

28. The hard disk drive storage system of claim 27, wherein said top flux plate is substantially dimensionally identical to said middle flux plate.

29. The hard disk storage drive system of claim 26, wherein said coils are electrically coupled.

30. The hard disk drive of claim 29, wherein said coils are coupled in series and said magnets are coupled in series.

31. The hard disk drive of claim 26, wherein said magnets are all substantially dimensionally identical.

32. The hard disk drive of claim 31, wherein said magnets have a thickness of less than approximately 0.15 inches.

33. A family of hard disk drive digital storage systems of different height, comprising:
a half-height drive including a head positioner arrangement having a permanent magnet structure having a pair of fixed substantially flat spaced permanent magnets mounted on a plurality of flux plates; and a movable head positioner having a coil extending between said magnets for controlling the movement of said heads; and
a full-height drive including a head positioner arrangement with a permanent magnet structure having a plurality of flux plates and at least two pair of fixed substantially flat spaced permanent magnets, and a movable head positioner having two coils with each coil extending between one of said pairs of magnets for controlling the movement of said heads, said two coils being fixedly mounted with respect to one another.

34. The family of hard disk drive digital storage systems of claim 33, wherein the total number of windings in said coils of said full-height drive is approximately the same as the number of windings of said coil of said half-height drive.

35. The family of hard disk drive digital storage systems of claim 34, wherein the windings in said coils in said full-height drive are approximately three wire sizes larger than the windings in said coil of said half-height drive.

36. The family of hard disk drive digital storage systems of claim 33, wherein said coils of said full-height drive are electrically coupled.

37. The family of hard disk drives digital storage systems of claim 33, wherein said pairs of magnets for said full-height drive are substantially identical with said pair of magnets for said half-height drive.

38. The family of hard disk drive digital storage systems of claim 37, wherein said plurality of flux plates in said full-height drive include a first pair of flux plates having substantially identical dimensions and a lower flux plate, and said plurality of flux plates in said half-height drive includes a top flux plate having substantially identical dimensions to said first pair of flux plates and a bottom flux plate having substantially identical dimensions to said lower flux plate.

39. The family of hard disk drive digital storage systems of claim 38, wherein said coils of the full-height drive are interposed between said pairs of magnets in the full-height permanent magnet structure.

40. The family of hard disk drive digital storage systems of claim 37, wherein said two coils in said full-height drive are coupled in series.

41. The family of hard disk drive digital storage systems of claim 40, wherein said two coils in said full-height drive comprise approximately the same number of total windings as the coil in the half-height disk drive.

42. The family of hard disk drive digital storage systems of claim 37, wherein all magnets in said full-height drive and said half-height drive have substantially identical dimensions.

43. The family of hard disk drive digital storage systems of claim 42, wherein all magnets in said full-height drive are coupled in series.

44. The family of hard disk drive digital storage systems of claim 43, wherein all magnets in said half-height drive are coupled in series.

45. An integrally formed head positioner for use in a hard disk drive digital storage system, including:
a base;
a plurality of arms mounted to said base; and
a plurality of coils mounted to said base.
